(19) United States
(12) Patent Application Publication
(10) Pub. No.: US 2009/0069956 A1
(43) Pub. Date: Mar. 12, 2009

(54) Central control system of wireless remote-control model

(76) Inventors: Shigetada Taya, Yokohama city (JP); Arakawa Noboru, kawagoe city (JP)

Correspondence Address: TROXELL LAW OFFICE PLLC, SUITE 1404, 5205 LEESBURG PIKE, FALLS CHURCH, VA, 22041, US

(21) Appl. No.: 12/071,752

(22) Filed: Feb. 26, 2008

(30) Foreign Application Priority Data
Feb. 26, 2007 (JP) 2007-045459

(51) Int. Cl. G05D 1/00; G05B 19/18

(52) U.S. Cl. 701/2; 318/569

(57) ABSTRACT

A central control system of a wireless remote-control model is capable of controlling a flight safety and effectively according to an operation control instruction signal data or a detector detection data instead of a single control value. Information such as the control, movement and abnormal detection of an electronic control machine installed on the wireless remote-control model are managed, determined and controlled jointly, so as to improve the safety and operability of the wireless remote-control model.

### BACKGROUND OF THE INVENTION

1. Field of the Invention

The present invention relates to a control of a wireless remote-control model, and more particularly to a central control system of a wireless remote-control model that can connect a driving machine of the model by using an instruction signal from a signal transmitter to control the posture or direction, so as to improve operability and safety.

2. Description of the Related Art

Wireless controlled models such as remote-control helicopters or vehicles are also known as wireless models or wireless remote controls, not only applied in the area of amateur hobbies, but also used extensively in many industries. Particularly, a wireless remote-control model using electric motor for its motive power (such as an electric wireless remote-control model) generally installs a signal receiver, a servomotor, a speed controller, a gyroscope, an operation control device and a battery serving as a motive power source, used in an operation control machine and a control device for controlling the flying and driving of the wireless remote-control model. Further, it is necessary to appropriately set parameters (or desired operation control parameters) in advance for controlling standards such as a steering angle characteristic or a power output characteristic or freely change the settings of the aforementioned operating parameters to achieve different operation control modes.

If a wireless remote-control model is used for flying or driving, it is necessary to appropriately set or change the shudder operating angle or the power output. For instance, an axial output of an electric motor is set to be nonlinear when the electric motor is used as a power source for a wireless remote-control helicopter, and a nonlinear change can achieve a very good operability and controllability. For an adjustment of a change to the gain or linearity of a shudder operating portion, the aforementioned axial output of the electric motor can be set, while obtaining a good control of operations and providing the fun of the wireless remote-control model to users. The settings of these operation control characteristics are divided into a mechanical portion such as the fixed angle of a servo swinging arm with respect to the driving axle of the servomotor and the connecting position of the servo swinging arm and a connecting wire, and an electric portion such as an electric output value set by a program. In recent years, the functions of the portion implemented by programs are extended such that detailed and diversified setup can be achieved.

A memory medium for storing memory control mode information is built in a wireless remote-control model, and the information stored in the memory medium is used for operating and controlling an object of the wireless remote-control model, and this prior art has been disclosed in a patent literature 1 (Japan Patent Laid Open Publication No. 2006-346144 of KOKAI Gazette). In a patent literature 2 (Japanese Published Unexamined Application No. 6-312065 Gazette), the patent literature 2 disclosed that the set value of a maximum allowed current of a power motor is stored in a memory in the driving of a wireless electric control car, and is an object-changed according to an instruction from the signal transmitter.

As the wireless remote-control model using a power motor as its motive power source becomes increasingly popular, more and more users or operators having little knowledge or not familiar with the wireless remote-control model, and thus it is necessary to assure the safety of the electric motor with a large output as well as the safety of the battery with a large energy capacity. Thus, the safety requirement should be taken into consideration, while the performance of the wireless remote-control model is being enhanced.

If the setup information change method disclosed in the aforementioned patent literature 2 is used, more diversified parameter settings can be set or reset. FIG. 6 illustrates an embodiment of the setup and change of a foregoing desired control parameter of a signal receiver. FIG. 7 is a schematic view illustrating an electronic apparatus of the wireless remote-control helicopter as depicted in FIG. 6, wherein a wireless remote-control helicopter that uses an electric motor as a motive power is used as an example for illustrating the wireless remote-control model. In FIG. 6, the wireless remote-control helicopter 100 is operated and controlled by a signal transmitter 300. The wireless remote-control helicopter 100 carries a driver control circuit 101 and a battery 17, and the driver control circuit 101 as shown in FIG. 7 includes a memory 4 for controlling a setup information (or a control parameter) or a computation control circuit 5 and a driver 14, 15. An operation control instruction signal from the signal transmitter 300 is received by a signal receiving antenna 102 to drive and control a servomotor for a power motor, a collective pitch, a rudder, an elevating shudder and an aileron, etc.

A signal transmitter 300 comprises operating rods 301, 302, a display device 303 for displaying the setup characteristics, a signal transmitting antenna 304, a power switch, channel selectors 307, 308 and other switches 305, 306 etc. The foregoing setup (desired setup and change of operation control parameters) is mainly used in the setup and adjusting functions of a signal transmitter for operating and controlling the wireless remote-control model by selecting a specific channel and switches 307, 308.

The wireless remote-control helicopter 100 receives the setup information by a signal receiver, and amplifies and detects waves by a high-frequency processing portion (RF portion) 2A, and decodes the information by a decoding portion 2B into a driving signal provided to a driver 14 of a power motor 7 and a driver 15 of a servomotor. As described in patent literature 2, this method can be applied to a change of one information setup. However, it is necessary to install the same quantity of functional components such as circuits and switches in the signal transmitter 300 for setting or changing the control parameters for a plurality of setup information by the aforementioned method.

In this type of wireless remote-control model, an operation control machine (or a signal transmitter 1) installed on the wireless remote-control model just has the capability of decoding separate operation control instruction by the signal receiver 2, but it cannot link the information between machines to control a flexible application. Therefore, the significance of the voltage, current and temperature management is the same, not only unable to precisely respond to abnormal voltage, current and temperature of a battery for a safe application, but also unable to maximize the utility of the power motor or the capability of the installed battery.

### SUMMARY OF THE INVENTION

The primary objective of the present invention is to provide a central control system of wireless remote-control model to overcome the foregoing shortcomings, and the system manages the information of the control, movement, and abnormality detection of an electronic control machine installed on a wireless remote-control model to improve safety and operation performance.

To achieve the foregoing objective, the present invention comprises the following elements:

An electronic control device installed in a wireless remote-control model comprises: a signal receiver with a decoder for decoding a signal from a signal transmitter received by a signal receiving circuit into an operation control instruction signal; and a driver control circuit, having one or a or plurality of servomotors and batteries for controlling a drive motor and handling a posture or a speed of a machine according to the operation control instruction signal decoded by the decoder. The driver control circuit includes a memory and a central control device, and the memory includes a set value storage portion for storing a control parameter setting of the generated operation control instruction signal.

The central control device comprises: a control signal generating portion, for generating a decoded operation control instruction signal according to the control parameter setting stored in the set value storage portion; and a central control portion, for managing a plurality of operation control instruction signals, and reflecting each other; and the central control portion is provided for generating an output to control the drive motor and the servomotor.

The memory further includes a history storage portion, for storing a movement history of the servomotor for controlling the drive motor and a machine that handles the posture or speed and the battery, such that a remaining operating time can be figured out by the stored movement history. The memory further comprises a history storage portion and an ID storage portion of the machine, and the ID storage portion stores IDs of the servomotor and the battery for controlling the drive motor and the machine that handles the posture or speed.

The load history of the servomotor for controlling the drive motor and the machine that handles the posture or speed and the movement history of the battery are combined with each ID stored in the ID storage portion, and stored in the history storage portion, such that the movement history of each installed machine is used for predicting the remaining operating time. The movement history of the battery includes normal rated data such as its capacity or discharge characteristic, a number of times of past abnormal current and a current flow, and a number of charging/discharging times; the load history of the drive motor includes normal rated data such as its maximum rotation speed and maximum consuming current, a rotation speed and a using time; and the load history of the servomotor includes normal rated data such as a rotation angle, a torque and an operating current, and a load and a past using time.

The invention further comprises: a driver control circuit, having one or a plurality of servomotors and batteries for controlling the drive motor and a machine that handles the posture or speed according to the operation control instruction signal decoded by the decoder; and a detector portion, for monitoring the status of the installed machine.

The driver control circuit includes a memory and a central control circuit, and the memory includes a set value storage portion for storing a control parameter setting of the generated operation control instruction signal, and the central control circuit comprises: a control signal generating portion, for generating a decoded operation control instruction signal according to the control parameter setting stored in the set value storage portion and the detection signal of the detector portion; and a central control portion, for managing a plurality of operation control instruction signals, and reflecting with each other; and an output produced by the central control portion for controlling the drive motor and the servomotor.

The central control portion predicts a rotation load for operating and controlling an output, or adds a change of rotation load of the drive motor detected by the detector portion or a change of voltage of the battery into the generated operation control instruction signal in advance to provide a feed forward control speed adjusting function for adjusting the speed of the drive motor.

The detector portion includes detectors for the current, voltage and temperature of the battery, detectors for the rotation angle and the angular speed of the frame body, and detectors of the servomotors. The memory includes a history storage portion for storing a movement history of the servomotors and the batteries for controlling the drive motor and the machine that handles the posture or speed, and a detection signal of the detector portion, so that the stored movement history and the detection signal of the detector portion are used for predicting the remaining operating time or the life of the battery, the drive motor and the servomotor.

The movement history of the battery includes normal rated data such as its capacity or discharge characteristic, a number of times of producing abnormal current in the past and a current flow, and a number of charging/discharging times; the movement history of the drive motor includes normal rated data such as its maximum rotation speed and maximum consuming current, a rotation speed and a using time; and the movement history of the servomotor includes normal rated data such as a rotation angle, a torque, and an operating current, a load and a past using time.

The memory of the invention includes a history storage portion and an ID storage portion installed in a machine, and the ID storage portion stores IDs of the drive motor and a machine that handles the posture or speed for controlling a servomotor and the battery, so that the load history of the servomotor for controlling the drive motor and a machine that handles the posture or speed, the movement history of the battery, and the detection signal of the detector portion are combined with each ID stored in the ID storage portion and stored in the history storage portion.

The remaining operating time or the life of the battery, the drive motor and the servomotor can be predicted by the movement history stored in each installed machine.

In the present invention, the change of a desired operation control parameter (which is an operation of setup information) is achieved by connecting to an external device of the control device through a communication line. Although the external device is preferably a personal computer (PC), other information setup device with the same function can be used. The PC must be changed or set to the desired values on a screen according to the desired operation control parameters of the wireless remote-control model to generate new operation control parameters (new setup information). The new setup information is transmitted via the communication line and stored directly into a set value storage area of a memory of a control device installed on the wireless remote-control model.

A portion of a frame body of the wireless remote-control model includes an external input terminal for connecting the communication line. When the wireless remote-control model is at a stop status, the communication line is connected to the PC for performing the aforementioned operation.

Further, an operation control simulated software of a wireless remote-control model is installed in the PC, such that the operation control simulated software of the PC can be executed to simulated control and operation according to the setup of parameter information and the change of set values.

The above and other objectives and advantages of the invention become apparent with the preferred embodiments and their drawings.

Of course, modifications are allowed for equivalent elements or arrangements of equivalent elements, and preferred embodiments accompanied with related drawings are chosen for the detailed description of the structure of the present invention.

### BRIEF DESCRIPTION OF THE DRAWINGS

FIG. 1 is a schematic view of a central control system of a wireless remote-control model in accordance with the present invention;

FIG. 2 is a block diagram of a central control system of a wireless remote-control model in accordance with a preferred embodiment of the present invention;

FIG. 3 is a flow chart of generating an operation control instruction signal at a control signal generating portion as depicted in FIG. 2;

FIG. 4 is a flow chart of a control sequence of a central control circuit as depicted in FIG. 2;

FIG. 5 is an overall side view of controlling a wireless remote-control helicopter in accordance with a preferred embodiment of the present invention;

FIG. 6 is a schematic view of setting and changing desired operation control parameters by using a signal transmitter in accordance with the present invention; and

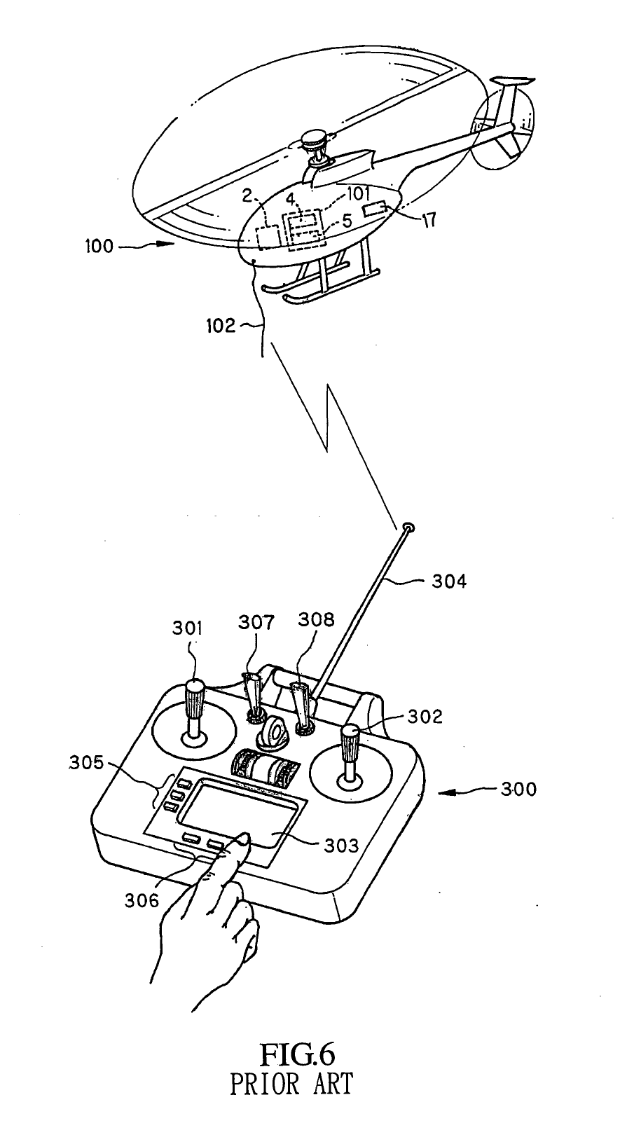

FIG. 7 is a schematic view of operating and controlling an electronic machine installed in a wireless remote-control helicopter as depicted in FIG. 6.

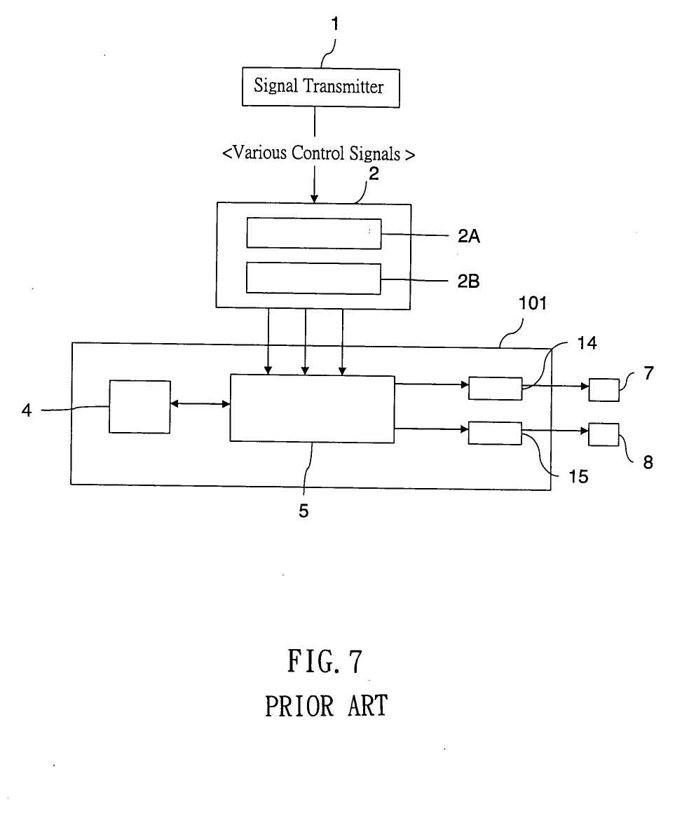

### DETAILED DESCRIPTION OF THE PREFERRED EMBODIMENTS

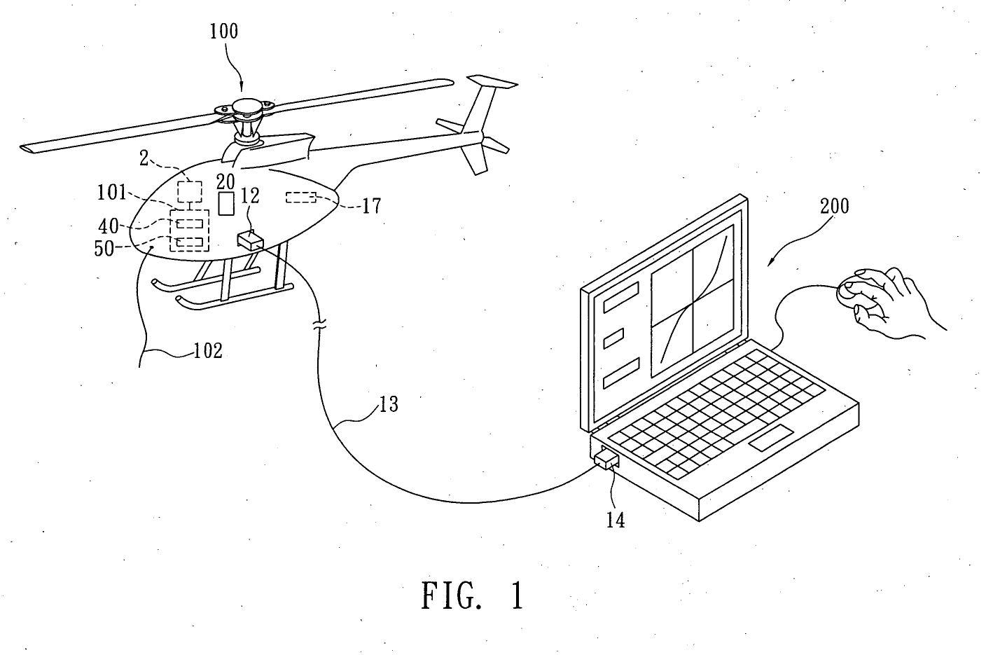

Refer to FIG. 1 for a schematic view of a central control system of a wireless remote-control model in accordance with the present invention, wireless remote-control helicopter is used as an example of the wireless remote-control model, and the central control system is connected to an external device for the use of the central control system. The external device is a personal computer (PC). In this embodiment, a driver control circuit 101 together with a signal receiver 2 and/or a battery 17 installed on a wireless remote-control helicopter 100 includes a memory 40 and a central control circuit 50. The wireless remote-control helicopter further includes a detector portion 20 comprised of detectors for detecting the status of each electronic machine such as the battery 17, power motor and servomotor installed on the wireless remote-control helicopter 100.

The wireless remote-control helicopter 100 further includes a connector 12, such that when the control parameter setting is stored in the memory 40, or a history information stored in the memory 40 is retrieved, a communication line 13 is connected to the connector 12 and a connector 14 of the external device which is the personal computer (PC). The signal receiver 2 includes a high-frequency (RF) processing portion, a wave detection portion and a decoder.

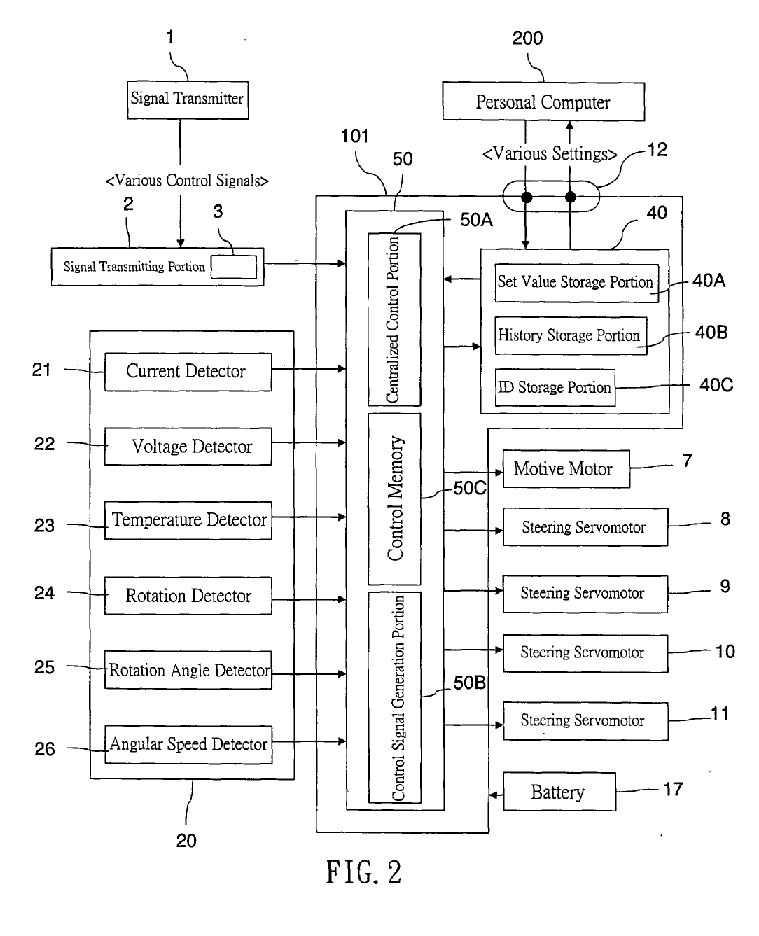

Referring to FIG. 2 for a block diagram of a central control system of a wireless remote-control model in accordance with a preferred embodiment of the present invention, and an assembly of a driver control circuit 101 as shown in FIG. 1 is described in detail, and the battery, detector portion and power motor are connected to each type of servomotor. In FIG. 2, the same numerals are used for the same element with the same function as depicted in FIG. 1, and the numeral 11 stands for a signal transmitter, 2 for a signal receiver, 3 for a decoder, 20 for a detector portion, 21 for a current detector, 22 for a voltage detector, 23 for a temperature detector, 24 for a rotation detector, 25 for a rotation angle detector, 26 for an angular speed detector, 7 for a power motor, 8˜11 for steering servomotors, 12 for a connector on a wireless remote-control helicopter, 13 for a communication line, 14 for a connector on a PC, 17 for a battery, 40 for a memory, 40A for a set value storage portion, 40B for a history storage portion, 40C for an ID storage portion, 50 for a central control device (CPU), 50A for a central control portion, 50B for a control signal generating portion, 50C for a control memory, and 200 for a personal computer (PC).

The current detector 21, voltage detector 22 and temperature detector 23 are detectors for detecting the current, voltage and temperature. The rotation detector 24 is provided for detecting an output shaft of the power motor or the rotation speed of a rotor. The rotation angle detector 25 and angular speed detector 26 are detectors for detecting a shudder operating angle, a rotation angle and an angular speed of servomotors, which can also be calculated by the number of driving pulse and pulse width of the servomotors. The servomotors are installed at the flying control portions such as the rotor pitch, shudder and aileron, etc.

In the assembly as shown in FIG. 1, the PC 200 is changed or the control parameter settings stored in the memory of the wireless remote-control helicopter 100 are adjusted, before or after the wireless remote-control helicopter 100 flies, and thus the status and the history of each portion installed in the machine are confirmed to be of the same operation. In one of the operations, the control parameter settings (including the driving characteristics of a power motor and the operating characteristics of a collective pitch, a shudder, and an aileron, etc.) transmitted from the PC 200 through a communication line 12 is stored in the set value storage portion 40A of the memory 40.

During the periods when the power motor 7 of the wireless remote-control helicopter 100 starts rotating to take off, fly and land, modulated waves of each control signal of an operation control instruction signal transmitted from the signal transmitter 1 are received by the signal receiver 2 installed on the wireless remote-control helicopter 100. The received modulated waves are detected by the signal receiver 2 and decoded by the decoder 3, and then produced as each type of operation control instruction signal. The operation control instruction signal is generated by the control signal generating portion 50B of the central control circuit 50 according to a set value (a control parameter or a setup characteristic) according to the set value stored in the set value storage portion 40A of the memory 40.

The central control portion 50A includes a detector of the detector portion 20 for detecting a change of a rotation load of the drive motor and a change of voltage of the battery and adds the change to the generation of operation control instruction signal in advance, which carries out the so-called “Feed forward control”, so that the drive motor 7 has a function of adjusting a speed with a high precision.

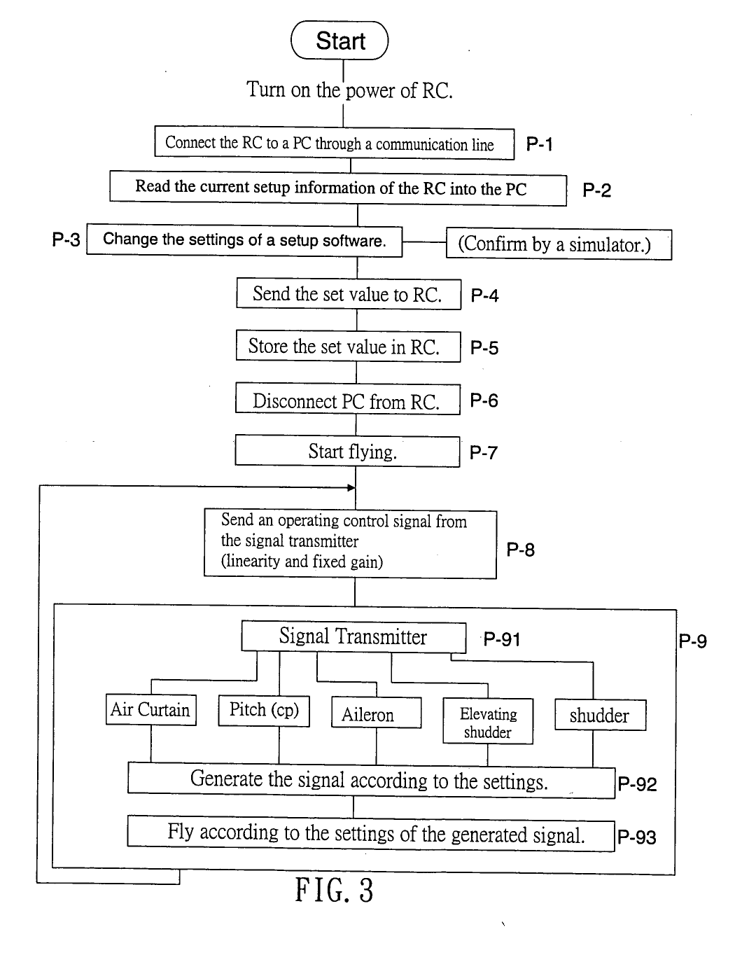

Referring to FIG. 3 for a flow chart of setting control parameters and illustrating a flying sequence in accordance with a preferred embodiment of the present invention, the operation control instruction signal is generated according to the set values, and each procedure is represented by (P-1), (P-2) and so on. In FIG. 3, a wireless remote-control helicopter (hereinafter referred to as “RC”) is powered ON. In (P-1), the RC is connected to the PC by a communication line (hereinafter referred to as “Electric Wire”). The current setup information (or current set value) of the RC is read into the PC. In (P-3), the set value set by the PC setup software is changed, wherein a simulation software is preferably used for confirming the change, but such procedure can be skipped.

In (P-4), the set value is sent to RC. In (P-5), the set value is stored in the set value storage portion 4A of the memory 4 of the RC. In (P-6), the electric wire is disconnected from the RC to set the RC in a standby state. In (P-7), a start flying instruction signal is sent from the signal transmitter to start flying the RC.

In (P-8), the operation control signal is transmitted from the signal transmitter during a flying state, wherein the operation control signal is linear and comes with a constant gain. In (P-9), the transmitted operation control signal is received by a signal receiver installed on the RC, and the driver control circuit is used for processing according to the set value. In other words, the signal receiver is provided for receiving, amplifying and detecting waves of high frequency signals. In (P-91), the signals are decoded by a decoder. In this embodiment, the operation control information transmitted from the signal transmitter is decoded to obtain the type of control signals including an air door (the rotation control of the power motor), a pitch (cp: pitch of the main rotor), an aileron, an elevating shudder, or a shudder. The operation control signal is any one of the above, and a plurality of operation control signals are processed in sequence. However, the control signal generating portion (microcomputer) comes with a powerful processing capability, and thus instruction signals transmitted from multiple channels to the system can be processed in parallel.

In (P-92), these decoded control signals are generated according to corresponding set values stored in the set value storage portion 4A of the memory 4. In (P-93), the RC controls each flying control portion for the operation according to the generated control signals. The driver control circuit 101 waits for a next operation control signal for the processing. After a new operation control signal is received, the procedure (P-9) is repeated.

Each of the foregoing generated operation control instruction signals is provided to a driving control mechanism at a later stage for controlling each controlled object. In other words, the embodiment as shown in FIG. 2 outputs a control signal and four steering signals from the control signal generating portion 5 to the power motor. The four steering signals include a collective pitch control signal, a shudder control signal, an aileron control signal and an elevating shudder control signal. Further, the power motor control signal is applied to the power motor 7 through a speed controller 6. The four steering signals (or control signals) are applied to the servomotors 8, 9, 10, 11 for controlling each control portion. According to the type of the wireless remote-control model, the power motor control signal and the steering signals are processed into control signals required for controlling and operating each control portion of the wireless remote-control model.

Each generated operation control instruction signal is provided to the power motor 7 or servomotor 8, 9, 10, 11 at a later stage, for controlling each controlled object. To cope with the type of the wireless remote-control model, the power motor control signal and the steering signal are converted into control signals for operating the control portion of the corresponding wireless remote-control model.

Each type of the detection signal for detecting the operation control instruction signal from the signal receiver 2 by the detector portion 20 stored as a set value in a set value storage portion 40A and the ID data of the battery 17, the power motor 7 and the steering servomotors 8, 9, 10 stored in the ID storage portion 40C are processed by the central control portion 50A in the central control circuit 50. In a preferred embodiment, if an instruction signal (or an expedition instruction) for increasing the flying speed is received, and the temperature of the power motor 7 detected by the temperature detector exceeds the predetermined temperature, the speed value for the instruction signal is corrected and restricted, or the expedition instruction is ignored. The corrected control is stored in a control memory 50C for running the sequence of the program. If this situation occurs, the correction and the ID of the power motor 7 are stored as history information in the history storage portion 40B.

Therefore, not only one control value is adopted, but other related data of the operation control instruction signal or corresponding data detected by the detector are provided for controlling the flying safely and effectively. After each central control mode is set by a program installed in the PC 200 as shown in FIG. 1, the central control mode is stored in the control memory 50C. The control memory 50C can be a portion of the memory 40.

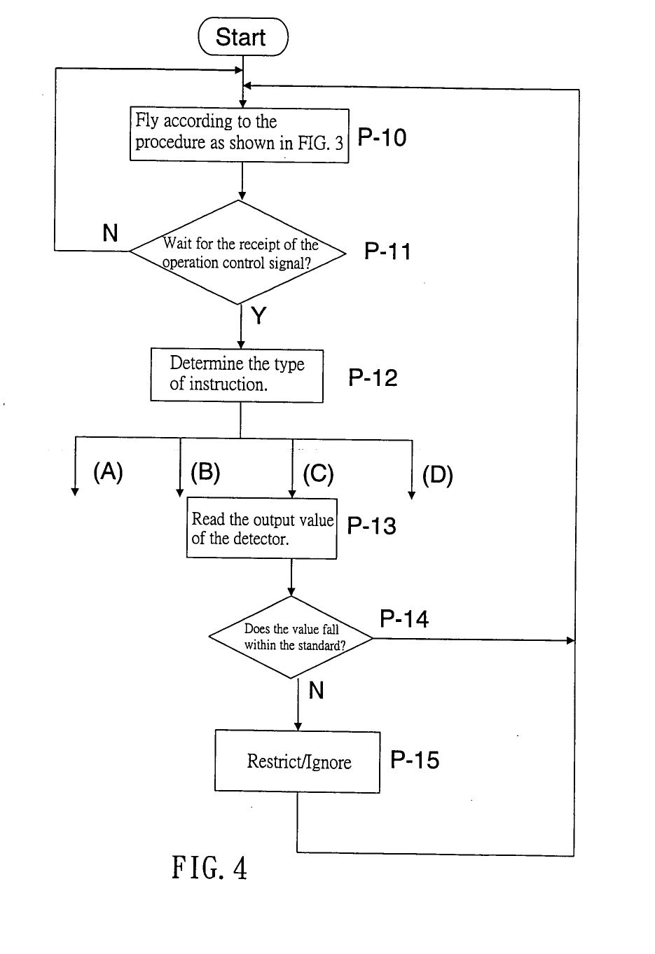

Referring to FIG. 4 for the central control in accordance with a preferred embodiment of the present invention, a flow chart of a control sequence of a central control circuit as depicted in FIG. 2 is illustrated. In the conditions of the central control, if the temperature of the power motor 7 detected by the temperature detector approaches the predetermined temperature, and the simulated speed increase instruction is transmitted from the signal transmitter, the instruction signal is decoded.

In (P-10), the wireless remote-control helicopter (RC) flies according to the procedure as shown in FIG. 3. In (P-11), the operation control instruction transmitted from the signal transmitter is received, and the central control portion 50A determines the type of the instruction. The operation control instruction signal is generated by the sequence as shown in FIG. 3, and processed in parallel in the sequence as shown in FIG. 4. In (P-12), the central control portion 50A determines and classifies the type of the operation control instruction signal. If an instruction (C) is to increase the pitch, the instruction implies the increase of the load of the air force, and the load of the power motor is increased.

In (P-13), the detection value is detected by a corresponding detector according to the classified instruction (C). The detector is a temperature detector of the power motor 7 and a voltage detector of the battery. In (P-14), the flying is carried out according to the instruction, if the detection values of the detectors fall within a range of the standard of the instruction signal. In (P-15), if the detection value of the detector is not up to the standard value of the instruction signal (such as the temperature of the power motor 7 becomes abnormally high), a safe value below the predetermined temperature is restricted, or the instruction signal is ignored, and a safe posture is adopted. For other instruction signals, they are processed in the same way, or each operation control portion or detector is connected to carry out the central control. Therefore, the control by connecting related detector or instruction signal can provide a safe flying.

In this embodiment, a computer flying operation simulation software of the wireless remote-control helicopter installed on the PC adds the setup information, and links simulated detection data detected by each detector with control parameters of the operation control simulation, such that when the computer simulation executed by the PC for flying a wireless remote-control helicopter, each operating condition is reflected on a screen of the PC through a signal transmitter or a PC keyboard.

The instruction value of the operation control instruction signal including a signal transmitted from the signal transmitter is linear and an ungenerated signal with a pulse width or a linear characteristic uses default settings of the signal transmitter. The linear instruction value transmitted from the signal transmitter is stored as a set value stored in a set value storage portion of a memory installed on a frame body of the wireless remote-control helicopter, and used for generating a pulse width or a curve to control the control portion. In the meantime, the control as shown in FIG. 4 is carried out to assure safety.

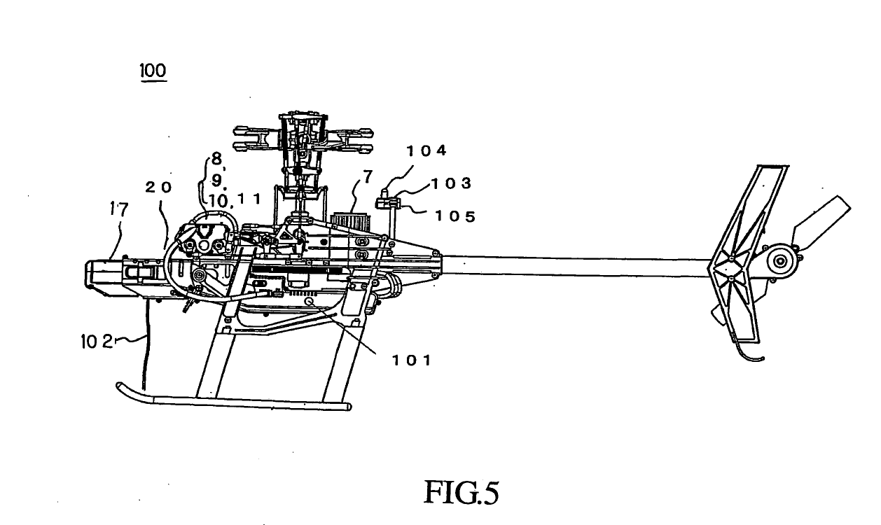

Referring to FIG. 5 for an overall side view of controlling a wireless remote-control helicopter in accordance with a preferred embodiment of the present invention, the wireless remote-control helicopter 100 installs a battery 17 at a front end of the wireless remote-control helicopter 100, a servomotor 8, 9, 10, 11 and a driver control circuit 101 of a central control system disposed at the middle of the wireless remote-control helicopter 10. Each detector portion is disposed at a carrying portion of the battery 17, and adjacent to a power motor as well as another machine, and the detector is installed at a carrying portion of the driver control circuit 101 and any other appropriate portion. In FIG. 5, a start press key 103 is disposed at the back side of the frame body. A light emitting diode 104 and a buzzer 105 are provided for alerting the operations of starting, warning and applying the wireless remote-control helicopter 100, and other machines are installed according to the design of the wireless remote-control helicopter 10.

In the setup of control parameters as shown in FIG. 3, the aforementioned electric setup is carried out by the setup and adjusting function of the signal transmitter, but there are limitations on the size and the cost of the signal transmitter, and thus the quantity of input switches for the setup function, or the function and the size of a display device for displaying the setup information are limited as well, and thus making the input for a detailed setup relatively uneasy. The operability or functionality also has limitations. In this embodiment, the wireless remote-control model includes a storage portion having an electric setup information, and the setup information is operated by connecting the wireless remote-control model to the PC by a communication line while referencing the information displayed on the PC screen. The new setup information for operating the PC can be stored into the wireless remote-control model again through the communication line.

In this preferred embodiment, the information for the control, movement and abnormal detection are managed by an electronic control machine installed on the wireless remote-control model to determine the control, and thus the invention can improve safety and operability.

In summation of the above, the present invention uses a central control device (CPU) to manage the characteristic, movement status and history of a whole of the wireless remote-control model or primary electronic machines or components and connect them with each other for the control, so as to improve the stability and safety of the operation. In addition, the history of the installed machines can provide an easy determination whether or not a replacement or a repair of the installed machines is required.

In the present invention, the set values of operating control parameters are changed and stored in a memory of the wireless remote-control model without requiring a signal transmitter, and thus the invention can simplify, miniaturize and lighten the wireless remote-control model by eliminating the signal transmitter. The operations for changing and setting the setup information are performed by an information setup software (for setting the parameters and changing the sequence) which is installed in the PC, and the detailed relevant information is displayed for an easy understanding to facilitate the setup operation.

The movement history of each machine can be displayed on a screen of the PC for confirmation, when the wireless remote-control model is connected to the PC through a communication line. For the safety purpose, a warning lamp or a buzzer can be installed at the wireless remote-control model and the signal transmitter corresponding to each machine.

A flying or driving operation control simulation software of the wireless remote-control model installed in the PC links the simulated setting set by the PC and the simulated control parameter (or setup information) to implement the simulated setting and reflecting the computer simulation of the flying and driving of the wireless remote-control model on a PC screen through the signal transmitter or a keyboard, and allow users to conform and change the set values before actually setting the wireless remote-control model.

Further, the change of components (or functional components) of the wireless remote-control model is instructed to run the simulation software, so that the set value can fit the numeric value of the corresponding characteristics of the components automatically, and the computer simulation of flying and driving can be achieve to confirm the operation control mode for the new components.

In the foregoing embodiment, the wireless remote-control helicopter is taken as an example for illustrating the present invention, but the invention is not limited to such arrangement only, and a fixed-wing wireless controlled airplane, a wireless controlled car, a wireless controlled boat, or any other type of remote-control model are applicable to the invention.

While the invention has been described by means of specific embodiments, numerous modifications and variations could be made thereto by those skilled in the art without departing from the scope and spirit of the invention set forth in the claims.

In summation of the description above, a person ordinarily skilled in the art can understand and implement the invention to achieve its objectives, and the present invention complies with the requirements of patent application, and thus is duly filed for a patent application.

What is claimed is:

1. A central control system of wireless remote-control model, comprising:
a signal receiving circuit;
a signal receiver, having a decoder for decoding a signal received by said signal receiving circuit into an operation control instruction signal; and
a driver control circuit, for controlling a drive motor according to the operation control instruction signal decoded by said decoder and one or a plurality of servomotors and batteries for controlling a machine that handles posture or speed; wherein said driver control circuit comprises a memory and a central control device, and said memory includes a set value storage portion for storing a control parameter setting used for generating a set value of said operation control instruction signal, and said central control device includes a control signal generating portion for generating a decoded operation control instruction signal according to the control parameter setting stored in said set value storage portion; and a central control portion, for managing a plurality of operation control instruction signals, and reflecting each other; and said central control portion is used for generating an output to control said drive motor and said servomotor.

2. The central control system of wireless remote-control model as recited in claim 1, wherein the memory includes a history storage portion, and the history storage portion stores a movement history of a servomotor and said battery for controlling said drive motor and a machine that controls said posture or speed, so as to estimate a remaining operating time from the stored movement history.

3. The central control system of wireless remote-control model as recited in claim 1, wherein said memory includes a history storage portion and an ID storage portion installed to a machine, and said ID storage portion stores IDs of said servomotor and said battery for controlling said drive motor and said machine that handles posture or speed, such that a load history of said servomotor and a movement history of said battery provided for controlling said drive motor and said machine that handles the posture or speed are combined with each ID stored in said ID storage portion and stored in said history storage portion for predicting a remaining operating time according to the movement history stored in each installed machine.

4. The central control system of wireless remote-control model as recited in claim 2, wherein said movement history of said battery includes a normal rated data including its capacity or discharge characteristic, a number of times of past abnormal current and current flow, and a number of charging/discharging times;
said movement history of said drive motor includes a normal rated data including its maximum rotation speed, maximum consuming current, a rotation speed and a using time; and
said movement history of said servomotor includes a normal rated data including a rotation angle, a torque and an operating current, a load and a past using time.

5. The central control system of wireless remote-control model as recited in claim 3, wherein said movement history of said battery includes a normal rated data including its capacity or discharge characteristic, a number of times of past abnormal current and current flow, and a number of charging/discharging times;
said movement history of said drive motor includes a normal rated data including its maximum rotation speed, maximum consuming current, a rotation speed and a using time; and
said movement history of said servomotor includes a normal rated data including a rotation angle, a torque and an operating current, a load and a past using time.

6. A central control system of wireless remote-control model, comprising:
a signal receiving circuit;
a signal receiver, having a decoder for decoding a signal received by said signal receiving circuit into an operation control instruction signal; and
a driver control circuit, for controlling a drive motor according to the operation control instruction signal decoded by said decoder and one or a plurality of servomotors and batteries for controlling a machine that handles posture or speed;
a detector portion, for monitoring the status of said installed machine;
wherein said driver control circuit includes a memory and a central control device, and said memory includes a set value storage portion for storing a control parameter setting generated by said operation control instruction signal, and said central control device comprises: a control signal generating portion, for generating a decoded operation control instruction signal according to the control parameter setting stored in said set value storage portion and a detection signal of said detector portion; and a central control portion, for managing a plurality of operation control instruction signals, and reflecting with each other; and an output generated by said central control portion for controlling said drive motor and said servomotor.

7. The central control system of wireless remote-control model as recited in claim 6, wherein said detector portion comprises each detector of current, voltage and temperature of said battery, and each detector of rotation angle and angular speed of said servomotor.

8. The central control system of wireless remote-control model as recited in claim 6, wherein said central control portion predicts to operate and control a rotation load, or adds a change of rotation load of said drive motor detected by said detector portion and a change of voltage of said battery into the generation of said operation control instruction signal in advance to adjust the speed of said drive motor.

9. The central control system of wireless remote-control model as recited in claim 6, wherein said memory includes a history storage portion, and said history storage portion stores a movement history of a servomotor and said battery for controlling said drive motor and a machine that handles the posture or speed and a detection signal of said detector portion, such that said stored movement history and said detection signal of said detector portion are used for predicting the remaining operating time or the life of said battery, said drive motor and said servomotor.

10. The central control system of wireless remote-control model as recited in claim 9, wherein said movement history of said battery includes a normal rated data including its capacity or discharge characteristic, a number of times of past abnormal current and current flow, and a number of charging/discharging times;
said movement history of said drive motor includes a normal rated data including its maximum rotation speed, maximum consuming current, a rotation speed and a using time; and
said movement history of said servomotor includes a normal rated data including a rotation angle, a torque and an operating current, a load and a past using time.

11. The central control system of wireless remote-control model as recited in claim 10, wherein said memory includes a history storage portion and an ID storage portion installed to a machine, and said ID storage portion stores IDS of said servomotor and said battery for controlling said drive motor and said machine that handles posture or speed, such that a load history of said servomotor for controlling said drive motor and said machine that handles the posture or speed, a movement history of said battery, a detection signal of said detector portion and said each ID stored in said ID storage portion are combined and stored in said history storage portion for predicting a remaining operating time or the life of said battery, said drive motor and said servomotor according to the movement history stored in each installed machine.

12. The central control system of wireless remote-control model as recited in claim 7, wherein said memory includes a history storage portion, and said history storage portion stores a movement history of a servomotor and said battery for controlling said drive motor and a machine that handles the posture or speed and a detection signal of said detector portion, such that said stored movement history and said detection signal of said detector portion are used for predicting the remaining operating time or the life of said battery, said drive motor and said servomotor.

13. The central control system of wireless remote-control model as recited in claim 12, wherein said movement history of said battery includes a normal rated data including its capacity or discharge characteristic, a number of times of past abnormal current and current flow, and a number of charging/discharging times; said movement history of said drive motor includes a normal rated data including its maximum rotation speed, maximum consuming current, a rotation speed and a using time; and
said movement history of said servomotor includes a normal rated data including a rotation angle, a torque and an operating current, a load and a past using time.

14. The central control system of wireless remote-control model as recited in claim 13, wherein said memory includes a history storage portion and an ID storage portion installed to a machine, and said ID storage portion stores IDs of said servomotor and said battery for controlling said drive motor and said machine that handles posture or speed, such that a load history of said servomotor for controlling said drive motor and said machine that handles the posture or speed, a movement history of said battery, a detection signal of said detector portion and said each ID stored in said ID storage portion are combined and stored in said history storage portion for predicting a remaining operating time or the life of said battery, said drive motor and said servomotor according to the movement history stored in each installed machine.

15. The central control system of wireless remote-control model as recited in claim 8, wherein said memory includes a history storage portion, and said history storage portion stores a movement history of a servomotor and said battery for controlling said drive motor and a machine that handles the posture or speed and a detection signal of said detector portion, such that said stored movement history and said detection signal of said detector portion are used for predicting the remaining operating time or the life of said battery, said drive motor and said servomotor.

16. The central control system of wireless remote-control model as recited in claim 15, wherein said movement history of said battery includes a normal rated data including its capacity or discharge characteristic, a number of times of past abnormal current and current flow, and a number of charging/discharging times; said movement history of said drive motor includes a normal rated data including its maximum rotation speed, maximum consuming current, a rotation speed and a using time; and
said movement history of said servomotor includes a normal rated data including a rotation angle, a torque and an operating current, a load and a past using time.

17. The central control system of wireless remote-control model as recited in claim 16, wherein said memory includes a history storage portion and an ID storage portion installed to a machine, and said ID storage portion stores IDs of said servomotor and said battery for controlling said drive motor and said machine that handles posture or speed, such that a load history of said servomotor for controlling said drive motor and said machine that handles the posture or speed, a movement history of said battery, a detection signal of said detector portion and said each ID stored in said ID storage portion are combined and stored in said history storage portion for predicting a remaining operating time or the life of said battery, said drive motor and said servomotor according to the movement history stored in each installed machine.
